(19) United States
(12) Patent Application Publication
(10) Pub. No.: US 2015/0199247 A1
(43) Pub. Date: Jul. 16, 2015

(54) METHOD AND SYSTEM TO PROVIDE A UNIFIED SET OF VIEWS AND AN EXECUTION MODEL FOR A TEST CYCLE

(71) Applicant: Linkedln Corporation, Mountain View, CA (US)

(72) Inventor: Viral Sangani, Los Altos, CA (US)

(73) Assignee: Linkedln Corporation, Mountain View, CA (US)

(21) Appl. No.: 14/156,277

(22) Filed: Jan. 15, 2014

(51) Int. Cl. G06F 11/22

(52) U.S. Cl. CPC G06F 11/2273

(57) ABSTRACT

An example system to provide a unified set of views and an execution model for a test cycle is termed a test manager. A test manager may include a unified user interface and a presentation module. The unified user interface may be configured to provide and manage a test cycle of a computing application. The presentation module may be configured to present one or more views generated by the unified user interface.

### TECHNICAL FIELD

This application relates to the technical fields of software and/or hardware technology and, in one example embodiment, to a test manager, which is a computer-implemented system configured to provide a unified set of views and an execution model for a test cycle of a computing application.

### BACKGROUND

In software development, it is not uncommon to make changes to source code of a computing application. The changes may be made in order to include a new or enhanced feature, to fix a bug, etc. The resulting computer-implemented product may be, for example, an on-line social network, which may serve as an environment for connecting people in virtual space. An on-line social network may be a web-based platform, such as, e.g., a social networking web site, which may be accessible via a web browser, via a mobile application, etc.

In the process of testing of a computing application, a test team may be utilizing a variety of software tools, such as a word processing application for drafting test cases, a test case management system for editing test cases, etc. Many tasks are often performed manually, such as the task of keeping track of any changes to test cases, the task of analyzing and categorizing test results, etc. Furthermore, there is not always sufficient visibility into the progress of a testing cycle of a computing application. For example, developers of a computing application may not always know exactly what tests would be executed for a particular code change and may have to depend on the quality assurance team to provide this information.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to provide a unified set of views and an execution model for a test cycle may be implemented;

FIG. 2 is block diagram of a system to provide a unified set of views and an execution model for a test cycle, in accordance with one example embodiment;

FIG. 3 is a flow chart of a method for utilizing a test manager, in accordance with an example embodiment;

FIG. 4 illustrates an overview of an architecture 400 that incorporates a test manager, in accordance with an example embodiment; and

FIG. 5 is a diagrammatic representation of an example machine in the form of a computer system within which a set of instructions, for causing the machine to perform any one or more of the methodologies discussed herein, may be executed.

### DETAILED DESCRIPTION

An example system to provide a unified set of views and an execution model for a test cycle is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

In one embodiment, a system is provided to generate and make available a unified set of views and an execution model for a test cycle of a computing application. Such a system may be referred to as a test manager system or merely as a test manager. A computing application being tested may be, e.g., a web service or a collection of web services. For example, a computing application being tested may be an on-line social networking application designed and built as a collection of web services. For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members.

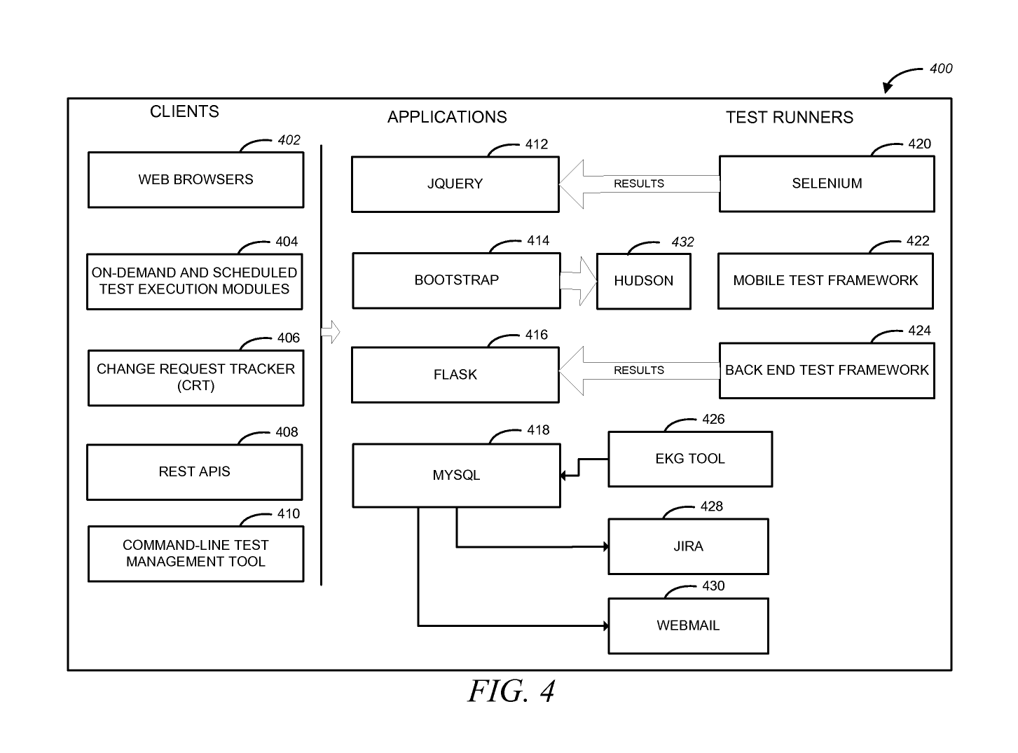

A test manager system (also referred to as merely a test manager) may be implemented as a web application or as a collection of web applications. A test manager may be integrated with other test tools within a development and testing system and may be configured to obtain information from the other test tools, as well as from one or more databases. An overview of architecture 400 that incorporates the test manager may be described with reference to FIG. 4.

As shown in FIG. 4, the architecture 400 comprises clients, applications, and test runners. In one embodiment, the clients of the architecture 400 include web browsers 402, on-demand and scheduled test execution modules 404, a change request tracker (CRT) 406, Representational State Transfer (REST) Application Programming Interfaces (APIs) 408, and command-line test management tool 410. The CRT client 406 is a system configured to create, modify, monitor, and report events occurring within a development and testing pipeline. The REST APIs may be used to invoke test execution remotely, to obtain the status of test execution, to aggregate the results of test execution, as well as to send auto alerts to designated recipients.

The application layer of the architecture 400 may include standard web technologies, such as HyperText Markup Language (HTML) and JQuery 412. Also may be used Bootstrap (414), which a toolkit for providing simple and flexible HTML, cascading Style Sheets (CSS), and JavaScript (JS) for popular user interface (UI) components. Bootstrap was developed by Twitter Inc., which is a social network company. The other applications are Flask (416), which is a micro framework written in Python, which allows one to write the application layer code, and an open source database MySQL 418, which may be used as a back end. The test runners integrated in the architecture 400 include Selenium (420), which is a UI test framework, a mobile test framework 422, and the back end test framework 424, which is written in Java. The mobile test framework 422 is provided for testing on mobile devices and their respective native operating systems.

Other systems provided within the architecture 400 are an EKG tool 426, Jira 428, and Webmail 430. The EKG tool 426 stores and parses the server logs and also stores exceptions detected at the server. Jira 428 is a system for creating bug reports for the failed test cases, using test cases metadata, test case execution information, and server logs that may be obtained from the EKG tool 426. Also shown in FIG. 4 is an execution engine 432 called Hudson. The execution engine 432 may invoke execution of test cases. Once the execution is triggered from any of the clients, the results are passed to the application layer, notifications are sent out, and the reports are created in Jira 428.

The information obtained and generated by various components of the architecture 400 may be utilized by the test manager in preparing web pages that are to be served to end users (e.g., to the test team, to the development team, to the management team, etc.). In one embodiment, a test cycle of a computing application includes several stages, such as, for example, test planning, preparation of test case definitions, review and approval of test cases, executing test cases by utilizing test scripts, monitoring the progress of test execution, and categorizing and reporting test failures. In one embodiment, a test manager may be configured to allow not only the testing team but also the developers to execute a test, analyze it, and report it.

In some embodiments a test manager maybe configured to permit scheduled, on-demand, and remote execution of test scripts. A test manager, in one embodiment, may be provided as with a command line component in addition to a graphical user interface (GUI). A test manager may utilize web technologies, such as HyperText Markup Language (HTML) and JQuery (a multi-browser JavaScript library), and may be integrated with various test frameworks, such as test frameworks for user interface testing, backend application interface testing, mobile web and device testing. A test manager may be configured to automatically create bug reports for the failed test cases, utilizing one or more additional computer-implemented tools that can store and parse test execution logs.

In some embodiments, the unified graphical user interface provided by the test manager includes a plurality of views. The views may be, e.g., in the form of dynamic web pages. For example, a test manager may include a plan and test case view that permits users to create, update, and delete test suites. There may also be a view that permits users to create, update, and delete projects and the associated test plans. Test Suites and Projects consist of collection of test cases and test plans respectively. A test plan is a configuration to execute a group of test cases. Other views provided by the test manager include test execution views to present real time data with respect to the status of the execution of the test cases and test analysis views to provide information with respect to potential causes of test failures. A test manager may also be configured to present one or more views for collaborative review, editing, and approval of test cases.

A test manager may also be configured to automatically synchronize test cases and the associated test scripts. A test script is a collection of instructions that permits running test cases automatically. A test case is a human-readable definition of steps to validate a feature or an end-to-end use case. In one embodiment, when a test case is created, the test manager generates a so-called stub for the associated test script. This stub can be committed to the version control system for further implementation of the instructions and execution of the test. A test manager provides a two-way synchronization of the test meta data between test case and test script. Test manager uses the stub to detect a change to the test case and automatically synchronize the metadata in the test case with the data in the associated test script. After synchronizing the metadata, the test manager also submits the changes to the version control system. The data being synchronized between the test case and the associated test script may include test case name, priority of the execution of the test case, identification of one or more services invoked by the test case, test case steps etc. Test cases may be stored in a database, while test scripts may be committed to a version control system.

As mentioned above, the test manager may include test analysis views to provide information with respect to potential causes of test failures by deriving patterns off of processing of errors and exceptions in the test script execution. Test analysis views may also display a visual representation of the failure categories. This may eliminate the need for the testing teams to perform manual analysis. The same view may also provide execution workflow and point of failure in human-readable format. This may assist end users from teams other than test authors to interpret the test work flow. The same view may also provide a history of execution details, including bugs reported in the past for the test in question. This can assist the end user relate failures to the past failures, which in turn allows for faster troubleshooting and resolution. A test manager may also be configured to permit management of the test failure processing. For instance, where the task of analyzing the failure can be delegated to different individuals or teams, a test manager may be configured to provide a view that can be used to delegate or assign analysis of test failures.

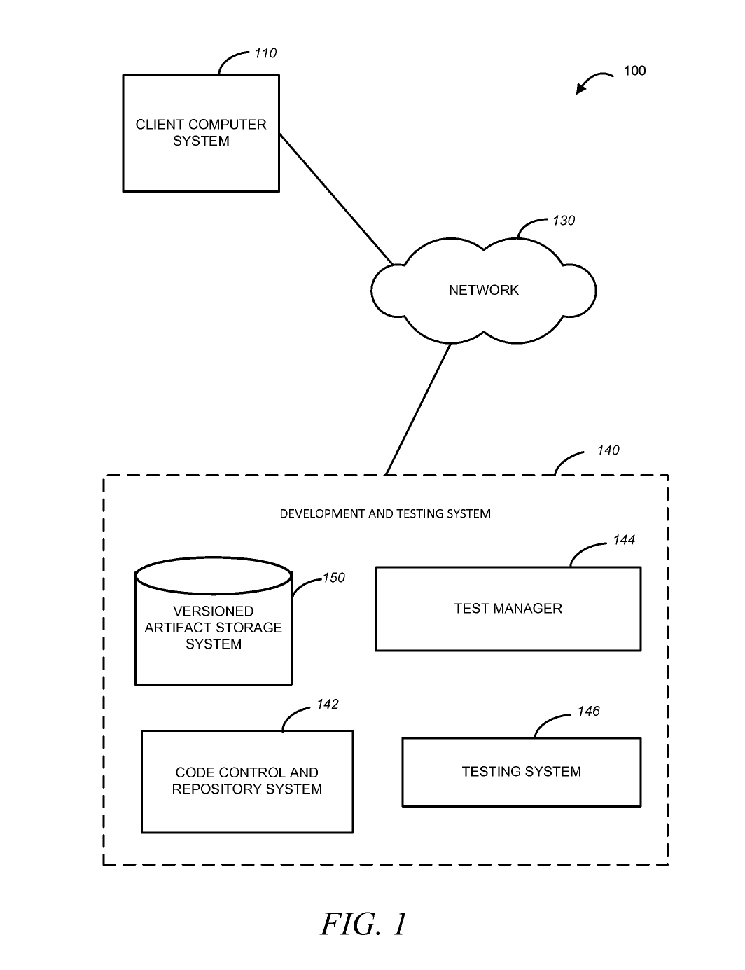

A test manager is thus a single computer-implemented tool that allows a user to define the scope of testing, assists test automation, allows to schedule and execute tests, to analyze the results of test execution, report the problems revealed by test execution, and certify the deployments. Deployment is an act of making the new and updated changes in the computer application available for the users of the application. The deployment system sends a trigger to the test manager for each deployment event. A test Manager generates the configuration for test plan dynamically if it doesn't exist already and triggers the test plan execution associated to the deployed changes. The scope of testing refers to a subset of test cases that may be executed in order to test a particular feature or a set of features of a computing application. An example system to provide a unified set of views and an execution model for a test cycle of a computing application—a test manager—may be implemented in the context of a network environment illustrated in FIG. 1.

As shown in FIG. 1, the network environment 100 may include a code control and repository system 142, a test manager 144, and a versioned artifact storage system 150, which collectively may be referred to as a development and testing system 140. The code control and repository system 142 may be configured to permit version control of application code, storing of the application code, etc. A version of a computing application code that has gone through a test and build pipeline successfully may be termed a versioned artifact and may be stored in the versioned artifact storage system 142. A versioned artifact may be deployed on a fabric. A fabric is a collection of computer systems in a data center that may be located remotely from the location of a server system hosting the change request tracker.

As described above, the test manager 144 is a computer-implemented tool that allows users to define the scope of testing, schedule and execute testing utilizing test cases and test scripts, analyze the results of test execution, report the problems revealed by the test execution, and certify the deployments. Test cases may be stored in a database (such as, e.g., the versioned artifact storage system 150), while test scripts may be committed to a version control system (such as, e.g., the code control and repository system 142). In one embodiment, the views generated by the test manager 144 may be accessible by users (e.g., developers, test team members, management team members, etc.) from their client machines, such as, e.g., from a client computer system 110, via a communications network 130. The communications network 130 may be a public network (e.g., the Internet, a mobile communication network, or any other network capable of communicating digital data).

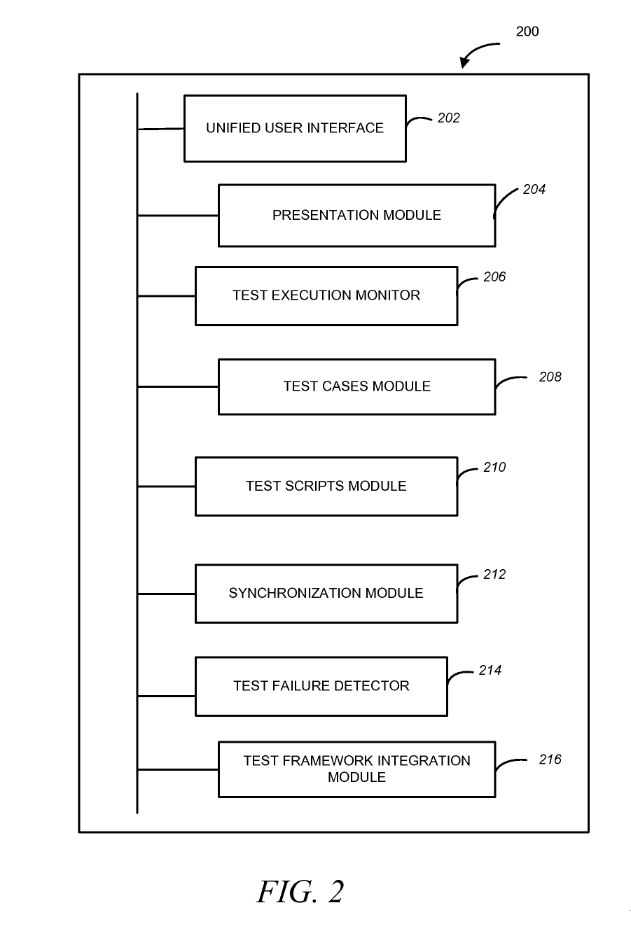

Example modules of a test manager are illustrated in FIG. 2. FIG. 2 is a block diagram of a test manager system 200. As shown in FIG. 2, the test manager system 200 includes a unified user interface 202 and a presentation module 204. The unified user interface 202 may be configured to provide and manage a test cycle of a computing application. A computing application may be, e.g., an on-line social networking system and may comprise one or more web services. The test cycle of a computing application may include various stages, such as, e.g., preparing test cases, executing the test cases, and analyzing results of the test execution. The presentation module 204 may be configured to present one or more views generated by the unified user interface 202. These views display data related to a state of the test cycle of the computing application. For example, the presentation module 204 may present a test case approval view that permits collaborative editing of the one or more test cases. The presentation module 204 may also present a failure analysis view that displays association between a particular test case and the details of the detected failure. Still further, the presentation module 204 may present an analysis delegation view that permits a user to assign analysis of some or all of the detected failures to one or more further users.

Also shown in FIG. 2 are a test execution monitor 206, a test cases module 208, a test scripts module 210, and a synchronization module 212. The test execution monitor 206 may be configured to monitor execution of test cases during a test cycle of a computing application. Users may be permitted to observe the progress of the test execution by accessing a test execution progress view provided by the presentation module 204. The presentation module 204 may utilize information monitored by the test execution monitor 206. The test cases module 208 may be configured to generate and maintain test cases. The test scripts module 210 may be configured to generate and maintain test scripts. As mentioned above, test scripts may be generated to permit executing the one or more test cases automatically. The synchronization module 212 may be configured to automatically synchronize the test scripts with the associated test cases, if any changes to the test cases are detected.

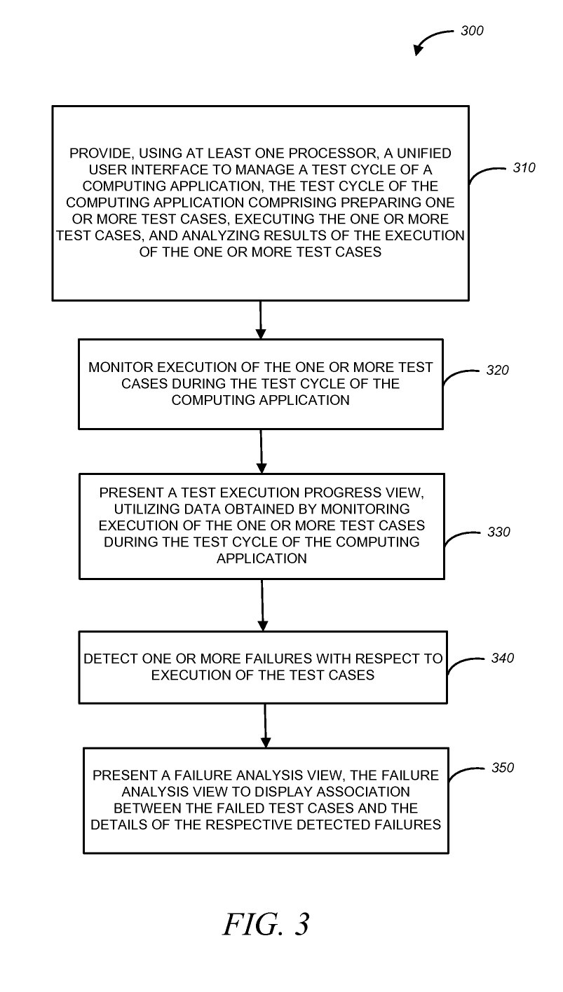

The test manager system 200 may also include a test case failure detector 214 and a test framework integration module 216. The test case failure detector 214 may be configured to detect failures of test cases that are used to test a computing application. The test framework integration module 216 may be configured to provide integration between the unified user interface 202 and one or more testing frameworks. A testing framework may be, e.g., a testing framework for one or more mobile devices, a testing framework for one or more desktop devices, etc. Example operations performed by the test manager system 200 may be described with reference to FIG. 3.

FIG. 3 is a flow chart of a method 300 for utilizing a test manager, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the development and testing system 140 of FIG. 1 and, specifically, at the test manager system 200 shown in FIG. 2.

As shown in FIG. 3, the unified user interface 202 of FIG. 2 is provided to manage a test cycle of a computing application (operation 310). As mentioned above, a computing application may be, e.g., an on-line social networking system and may comprise one or more web services. At operation 320, the test execution monitor 206 of FIG. 2 monitors execution of test cases during the test cycle of the computing application. Users may be permitted to observe the progress of the test execution by accessing a test execution progress view provided by the presentation module 204 of FIG. 2 (operation 320). The presentation module 204 utilizes information monitored by the test execution monitor 206 and presents an execution progress view, at operation 330. At operation 340, the test case failure detector 214 of FIG. 2 detects a failure with respect to execution of one or more test cases. The presentation module 204 presents, at operation 350, a failure analysis view. The failure analysis view is generated by the unified user interface 202 and displays association between the failed test cases and the details of the respective detected failures.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

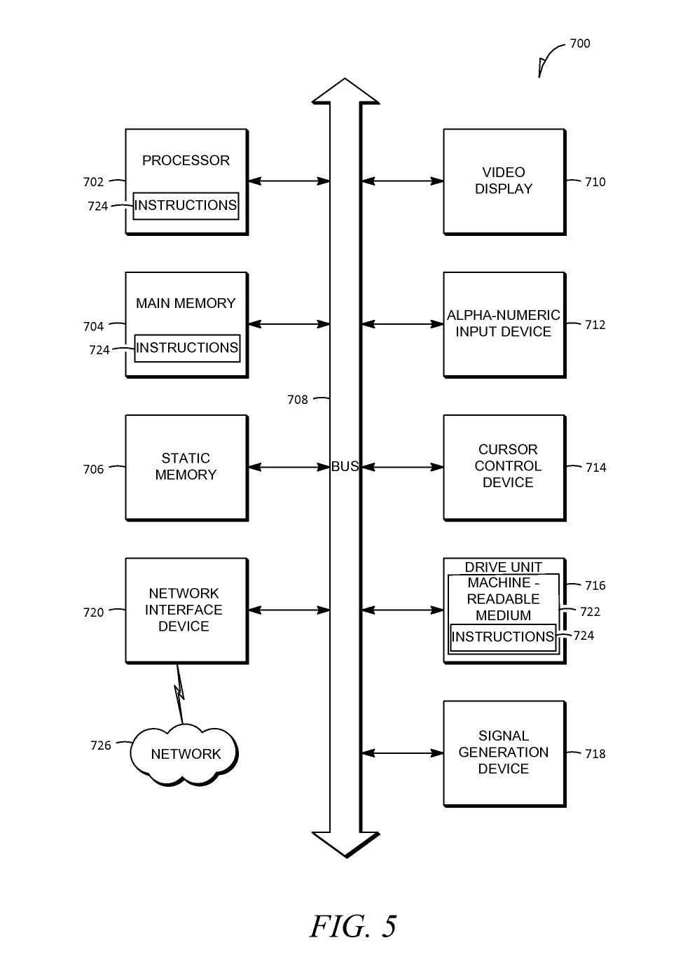

FIG. 5 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a target machine in a server-target network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, target or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a system to provide a unified set of views and an execution model for a test cycle of a computing application has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A method comprising:
providing, using at least one processor, a unified user interface to manage a test cycle of a computing application, the test cycle of the computing application comprising preparing of one or more test cases, executing of the one or more test cases, and analyzing results of the execution of the one or more test cases; and
presenting one or more views generated by the unified user interface, the one or more views to display data related to a state of the test cycle of the computing application.

2. The method of claim 1, wherein the computing application comprises one or more web services.

3. The method of claim 1, comprising:
monitoring execution of the one or more test cases during the test cycle of the computing application; and
presenting a test execution progress view with live streaming of test execution results, utilizing data obtained by monitoring execution of the one or more test cases during the test cycle of the computing application.

4. The method of claim 1, comprising:
a test cases module to provide the one or more test cases, the one or more test cases to test the computing application;
a test scripts module to provide one more test scripts, the one or more test scripts to permit executing the one or more test cases automatically, the test scripts module provided as part of a version control system; and
a synchronization module to synchronize the one or more test scripts with the one or more test cases responsive to detecting a change in the one or more test cases.

5. The method of claim 4, wherein the presentation module is to present a test case approval view, the test case approval view to permit collaborative editing of the one or more test cases.

6. The method of claim 1, comprising a test case failure detector to detect a failure with respect to execution of a particular test case from the one or more test cases.

7. The method of claim 6, wherein the presentation module is to present a failure analysis view, the failure analysis view to display association between the particular test case and execution details with point of failure of the detected failure.

8. The method of claim 6, wherein the presentation module is to present an analysis delegation view, the analysis delegation view to permit a user to assign analysis of the detected failure to one or more further users.

9. The method of claim 1, comprising a test framework integration module, the test framework integration module to provide integration between the unified user interface and one or more testing frameworks, the one or more testing frameworks comprising a testing framework for one or more of user interface testing, backend application interface testing, mobile web testing and one or more mobile devices.

10. The method of claim 1, wherein the computing application is an on-line social networking application.

11. A computer-implemented system comprising:
at least one processor coupled to a memory;
a unified user interface to manage a test cycle of a computing application, using the at least one processor, the test cycle of the computing application comprising preparing of one or more test cases, executing of the one or more test cases, and analyzing results of the execution of the one or more test cases;
a presentation module to present, using the at least one processor, one or more views generated by the unified user interface, the one or more views to display data related to a state of the test cycle of the computing application.

12. The system of claim 11, wherein the computing application comprises one or more web services.

13. The system of claim 11, comprising a test execution monitor to monitor, using the at least one processor, execution of the one or more test cases during the test cycle of the computing application, the presentation module to present a test execution progress view utilizing information monitored by the execution monitor.

14. The system of claim 11, comprising:
a test cases module to provide, using the at least one processor, the one or more test cases, the one or more test cases to test the computing application;
a test scripts module to provide, using the at least one processor, one more test scripts, the one or more test scripts to permit executing the one or more test cases automatically; and
a synchronization module to synchronize, using the at least one processor, the one or more test scripts with the one or more test cases responsive to detecting a change in the one or more test cases.

15. The system of claim 14, wherein the presentation module is to present a test case approval view, the test case approval view to permit collaborative editing of the one or more test cases.

16. The system of claim 11, comprising a test case failure detector to detect, using the at least one processor, a failure with respect to execution of a particular test case from the one or more test cases.

17. The system of claim 16, wherein the presentation module is to present a failure analysis view, the failure analysis view to display association between the particular test case and details of the detected failure.

18. The system of claim 16, wherein the presentation module is to present an analysis delegation view, the analysis delegation view to permit a user to assign analysis of the detected failure to one or more further users.

19. The system of claim 11, comprising a test framework integration module, the test framework integration module to provide, using the at least one processor, integration between the unified user interface and one or more testing frameworks, the one or more testing frameworks comprising a testing framework for one or more mobile devices.

20. A machine-readable non-transitory storage medium having instruction data to cause a machine to:
provide a unified user interface to manage a test cycle of a computing application, the test cycle of the computing application comprising preparing of one or more test cases, executing of the one or more test cases, and analyzing results of the execution of the one or more test cases; and
present one or more views generated by the unified user interface, the one or more views to display data related to a state of the test cycle of the computing application.
